(19) United States
(12) Patent Application Publication
(10) Pub. No.: US 2013/0025505 A1
(43) Pub. Date: Jan. 31, 2013

(54) LOW-STRENGTH AND LOW-DENSITY WATERPROOF PERLITE CONCRETE, AN AIRCRAFT-ARRESTING PAVING MATERIAL USING THE SAME, AND A PRODUCTION METHOD FOR THE SAME

(71) Applicant: Jae-Hyun Han, Seoul (KR)

(72) Inventor: Jae-Hyun Han, Seoul (KR)

(73) Assignee: THE KOREA TRANSPORT INSTITUTE, Goyang-si (KR)

(21) Appl. No.: 13/641,871

(22) PCT Filed: Apr. 19, 2011
(86) PCT No.: PCT/KR11/02800

§ 371 Date: Oct. 18, 2012

(30) Foreign Application Priority Data
Apr. 19, 2010 (KR) 10-2010-0035640

(51) Int. Cl. C04B 14/18; B29C 43/02

(52) U.S. Cl. 106/698; 264/299

(57) ABSTRACT

The present invention relates to an aircraft-arresting paving material which is installed in locations such as aircraft runway safety zones or landing strips and is adapted to ensure that an aircraft do not leave the runway, by itself breaking if an aircraft which has landed overruns or departs and as a result proceeds upwards, and the present invention relates to a production method for the same, and also to a low-strength waterproof perlite concrete produced so as to include perlite aggregate having a waterproof coating so as to be suitable as the overrun prevention paving material.

### TECHNICAL FIELD

The present invention relates to a low-strength and low-density waterproof-coated perlite concrete, an aircraft-arresting paving material using the same, and a method of producing the same. More particularly, the present invention relates to an aircraft-arresting paving material which is installed in a location, such as a runway safety zone or a landing strip of an airport, and is adapted to ensure that when a landing aircraft overruns or departs from the end of an runway to run on the aircraft-arresting paving material, the aircraft-arresting paving material breaks by itself to prevent the aircraft from departing from the runway. The present invention also relates to a method of producing such an aircraft-arresting paving material, and a low-strength and low-density waterproof perlite concrete produced to contain perlite aggregates which are waterproof-coated to be suitable as such an aircraft-arresting paving material.

### BACKGROUND ART

An airport runway is a very important installation for take-off and landing. In general, an aircraft should safely stop within the runway when it lands. Statistically, more than 10 incidents of overrunning aircraft, in which an aircraft travels over the end of an aircraft runway, happen annually on average at home and abroad. Due to the aircraft over-runs, expensive aircrafts are damaged and losses of precious life are caused.

Especially, most runways fall short of facility standards because they were constructed prior to establishing the current runway end safety area (RESA) standards. Recently, when constructing a runway, it is recommended that a standard runway safety area of 300 m (1,000 ft) be established in preparation for an aircraft over-run. However, in most cases, it is difficult to install such a standard runway safety area with the above-mentioned long length in addition to the runway due to various problems to be solved, for example, a natural obstacle, environmental damage, and a requirement for more land to be secured.

Thus, what is increasingly needed is to develop an aircraft-arresting paving material for safely stopping an overrunning aircraft while rapidly braking the aircraft rather than to extend the long runway safety area additionally.

### DETAILED DESCRIPTION OF THE INVENTION

### Technical Problem

The present invention has been made in an effort to solve the above-mentioned technical problems, and an aspect of the present invention is to provide an aircraft-arresting paving material which has a proper strength to be capable of breaking when a load of an aircraft is applied thereto and is formed from a light weight material to be capable of being easily transported and handled, and which is excellent in endurance and waterproofing performance, and to provide a method of producing such an aircraft-arresting paving material, and a material useful for producing such a paving material.

### Technical Solution

In accordance with an aspect of the present invention, there is provided a method of producing an overrun prevention paving material. The method includes: preparing perlite aggregates with a grain size of 1.5 mm to 2.0 mm and water in a weight ratio of 1:1, adding a siliconate to the prepared water to form a siliconate-diluted water, mixing the siliconate-diluted water and the perlite aggregates, and then drying the perlite aggregates naturally or drying the perlite aggregates at a temperature in the range of about 100° C. to 110° C. for more than 24 hours, thereby producing waterproof-coated perlite aggregates with a grain size of 1.5 mm to 2.0 mm; dry-mixing cement and the perlite aggregates in a volume ratio of 1:7 to 1:8; adding mixing water to the dry-mixed mixture of the cement and the perlite aggregates in a water/cement ratio (w/c ratio) of 50%, and mixing again the mixing water and the dry-mixed mixture, thereby producing a low-strength waterproof-coated perlite concrete; and pouring the low-strength waterproof-coated perlite concrete into a mold in an uncured state, compression-molding the low-strength waterproof-coated perlite concrete with a stress of 0.2 kg/cm² for about 1 minute, and after a lapse of about 24 hours, removing the mold to air-cure the low-strength waterproof-coated perlite concrete, thereby producing the overrun prevention paving material having a compression strength of 1.5 kg/cm² to 4.5 kg/cm², a porous ratio of 60% to 70%, and a unit weight of 0.25 g/cm³ to 0.5 g/cm³. In addition, an overrun prevention paving material produced by such a method, and a low-strength and low-density waterproof-coated perlite concrete are also provided.

### Advantageous Effects

According to the present invention, the waterproof-coated perlite aggregates are mixed with the mixing water to produce a concrete, and an aircraft-arresting paving material is produced using such a concrete. Since the waterproof-coated aggregates are used as a material for the concrete, it is easy to control the amount of the mixing water, and the concrete product produced in this manner is uniform in quality. Especially, upon being provided at an end of a runway, the inventive aircraft-arresting paving material, which is produced using a low-strength and low-density waterproof-coated perlite concrete containing the waterproof-coated perlite aggregates, may be usefully used as an aircraft-arresting (or aircraft-braking) material that is adapted to be destroyed under a road of an aircraft when the aircraft lands short of or overruns the end of the runway, thereby making the aircraft stop by itself.

In addition, the concrete used to produce the inventive aircraft-arresting paving material is easy to transport because it has a small unit weight. In addition, because waterproof-coated perlite aggregates are used as a material for the concrete to solve the disadvantages of conventional perlite aggregates which are highly absorbent, the inventive aircraft-arresting paving material is not deteriorated in endurance and exhibits an excellent waterproofing performance even if it is exposed to moisture, rain, dust and contaminants.

The features and advantages of the present invention will be more apparent from the following detailed description. However, terms or words used in the specification and claims shall not be construed merely in a conventional and dictionary definition but shall be construed in a meaning and concept corresponding to the technical idea of the present invention based on the principle that an inventor is allowed to properly define the concepts of terms in order to describe his or her invention in the best way.

### Mode for Carrying Out the Invention

Hereinafter, the present invention will be described by exemplifying several exemplary embodiments thereof. However, the present invention is not limited to these exemplary embodiments, and may be modified within the technical idea and scope of the present invention.

A low-strength and low-density waterproof-coated perlite concrete for producing the inventive aircraft-arresting paving material comprises perlite aggregates with a grain size of 1.5 mm to 2.0 mm, cement, and mixing water, the perlite aggregates being waterproof-coated by a siliconate.

The perlite aggregates are artificial aggregates produced from volcanic rocks, which have been already known in the art.

In using the perlite aggregates in concrete to be used for producing an aircraft-arresting paving material, if the grain size (grain diameter) of the perlite aggregates is less than 1.5 mm, it is difficult to secure a sufficient volume of voids which influences water drainage because the volume of the concrete is excessively reduced. In contrast, when the grain size of the perlite aggregates excesses 2.0 mm, the surface treatment of the concrete is difficult.

Accordingly, in the present invention, the grain size of the perlite aggregates is preferably in the range of 1.5 mm to 2.0 mm. The present invention waterproof-coats the perlite aggregates in the following manner so as to use the perlite aggregates as a material for a concrete to be used for producing an aircraft-arresting paving material.

Perlite aggregates with a grain size of 1.5 mm to 2.0 mm and water are prepared in a weight ratio of 1:1, and then a siliconate is added to the prepared water to produce a siliconate-diluted water. At this time, the siliconate is added to produce the siliconate-diluted water that contains the siliconate, preferably in a ratio of 100 g of siliconate per 1,000 g of water.

Taking the absorption rate of the perlite aggregates into consideration, the weight ratio of the perlite aggregates in relation to the water is preferably not more than 1 because the siliconate-diluted water may not be sufficiently mixed with the perlite aggregates if the weight ratio of the perlite aggregates in relation to the water exceeds 1.

For example, potassium methyl silicate may be used as the siliconate. After the siliconate-diluted water and the perlite aggregates are sufficiently mixed, for example, through impregnation (for example, after the siliconate-diluted water and the perlite aggregates are mixed to an extent that the siliconate-diluted water uniformly wets the surfaces of the perlite aggregates), the perlite aggregates may be dried at a temperature from 100° C. to 110° C. for more than 24 hours, thereby producing waterproof-coated perlite aggregates with a grain size of 1.5 mm to 2.0 mm.

Conventional perlite aggregates exhibit a high absorption rate of about 120% in weight ratio. Due to the high absorption rate of the conventional perlite aggregates, it is very difficult to control the amount of mixing water when the perlite aggregates are used as concrete aggregates. Accordingly, it becomes difficult to secure the uniformity of a concrete product in quality. However, the perlite aggregates waterproof-coated through the waterproof coating method as described above and newly proposed by the present invention hardly absorbs the mixing water since the absorption rate thereof is very low.

Accordingly, it is easy to control the amount of mixing water when the inventive waterproof-coated perlite aggregates as described above and the mixing water to produce concrete, and the concrete product produced thereby is uniform in quality.

The inventive low-strength waterproof-coated perlite concrete contains the cement and the waterproof-coated perlite with a grain size of 1.5 mm to 2.0 mm in a volume ratio of 1:7 to 1:8. That is, when the volume of the cement is 1, the volume of the perlite aggregates is 7 to 8. If the content of the cement is more than that in the case where the volume ratio is 1:7, the strength of the concrete may be increased to such an extent that it may not be destroyed when a weight of an aircraft is loaded on the concrete, and may not be suitable as an aircraft-arresting paving material. If the content of the cement is smaller than that in the case where the volume ratio is 1:8, the strength of the concrete may be excessively reduced to such an extent that an aircraft-arresting paving material may not be produced in a desired shape or may be produced to have a excessively low strength such that it cannot perform a function as a paving material at all.

Accordingly, in the inventive low-strength waterproof-coated perlite concrete, the volume ratio of the cement and the waterproof-coated perlite aggregates with a grain size of 1.5 mm to 2.0 mm is preferably 1:7 to 1:8. The most preferable volume ratio is 1:8.

In order to produce the inventive low-strength waterproof-coated perlite aggregates, the cement and the perlite aggregates measured as a weight ratio of 1:7 to 1:8 are dry-mixed, and then mixing water is added to and mixed again with the dry-mixed cement and perlite aggregates. At this time the mixing water/cement ratio, i.e. the water/cement ratio (w/c ratio) is preferably about 50%. That is, the cement and mixing water are mixed in a weight ratio of 100 to 50. About 5 minutes are adequate for mixing cement and mixing water after adding the mixing water to the cement. In addition, the mixing water, which is formed by adding a siliconate to water to be diluted, may be preferably used. The siliconate is added to the mixing water in an s/w ratio of 6%, i.e. in a ratio of 60 g of siliconate per 1,000 g of mixing water. If the s/w ratio exceeds 6%, the waterproofing performance of the perlite aggregates may be deteriorated, and if the s/w ratio is less than 6%, the bonding force of the cement may be deteriorated.

Accordingly, the s/w ration in the mixing water is preferably 6%. Since the present invention uses the siliconate-diluted water as the mixing water, the waterproofing performance of the cement surface is improved, which in turn increases the waterproofing force (water-repelling force) of the paving material against moisture in the air or in case of rain, and suppresses the absorption of moisture and water so that the degradation of endurance by moisture and water can be minimized.

Like this, the inventive low-strength and low-density waterproof-coated perlite concrete includes perlite aggregates with a grain size of 1.5 mm to 2.0 mm which are waterproof-coated with a siliconate, cement, and mixing water, in which the cement and perlite aggregates are contained in a volume ratio of 1:7 to 1:8, and the mixing water is added in a water/cement ratio of 50.

The inventive low-strength and low-density waterproof-coated perlite concrete has a low compression strength of about 1.5 kg/cm² to 4.5 kg/cm², a porous ratio in the range of about 60% to 70%, and a unit weight in the range of about 0.25 g/cm³ to 0.50 g/cm³. The inventive low-strength and low-density waterproof-coated perlite concrete exhibits a very ideal physical property as an overrun prevention paving material.

After the inventive low-strength and low-density waterproof-coated perlite concrete is produced by dry-mixing the cement and perlite aggregates, and then mixing again the cement and perlite aggregates after mixing water is added to the cement and perlite aggregates, the concrete is poured into a mold and compressed with a stress of about 0.2 kg/cm² for about 1 minute to produce a plate or block shape, and then the plate or block is air-dried for about 24 hours after removing the mold, thereby producing the inventive aircraft-arresting paving material.

### Test Examples

In order to confirm physical characteristics of the inventive low-strength and low-density waterproof-coated perlite concrete, perlite concrete specimens according to the present invention and perlite concrete specimens for comparison were produced. In that event, 15 cm-cube-shaped molds were used, and test specimens were produced by pouring concrete into the molds in the state in which they are completely mixed but not cured, and press-molding the concrete contained in the molds with stresses (“molding stresses”) of 0.05 kg/cm², 0.1 kg/cm², 0.2 kg/cm², and 0.3 kg/cm² for 1 minute, respectively.

TABLE 1

| | Volume ratio of | Cement | Perlite | | |
|---|---|---|---|---|---|
| | cement:perlite | weight | weight | | |
| Items | aggregates | (kg) | (kg) | w/c (%) | s/w (%) |
| Mixture 1 | 1:6 | 250 | 200 | 50 | 6 |
| Mixture 2 | 1:7 | 214 | 200 | 50 | 6 |
| Mixture 3 | 1:8 | 187 | 200 | 50 | 6 |
| Mixture 4 | 1:9 | 166 | 200 | 50 | 6 |
| Mixture 5 | 1:10 | 150 | 200 | 50 | 6 |

In Table 1, w/c means a water to cement ratio, i.e. the weight ratio of mixing water in relation to the cement weight of 100, and s/w means a siliconate to water ratio, i.e. the weight ratio of siliconate in relation to the water weight of 100, when the water is used for producing the siliconate-diluted water to be used as mixing water added when mixing the perlite aggregates and cement. In addition, in Table 1, the cement weight and the perlite weight indicate mixing ratios required for producing a concrete specimen of 1 m³.

The results of investigating the cubic specimens produced with the above-mentioned conditions showed that as the molding stress was increased in the order of 0.05 kg/cm², 0.1 kg/cm², 0.2 kg /cm², and 0.3 kg/cm², the unit weight of the concrete was also increased. However, the results of measuring the compression strengths of the completely cured specimens showed that as the molding stress is increased, the compression strength was also increased and when the molding stress was 0.2 kg/cm², the compression strength arrived at the maximum. However, when the molding stress was 0.3 kg/cm², the compression strength was reduced on the contrary. Consequently, it has been analyzed that these results were caused because the grains of the perlite aggregates were destroyed when an excessive molding stress was applied to the concrete in an uncured condition. Accordingly, it can be confirmed that a desirable molding stress for an uncured concrete which may be applied to the present invention is about 0.2 kg/cm².

In case of the mixture 1, which corresponds to a comparative example, the compression strengths of the specimens were about 5 k g/cm² to 7 kg/cm² when the concrete was in the cured condition, and the unit weights thereof was in the range of about 0.50 g/cm³ to 0.60 g/cm³ when the concrete is in the uncured condition, whereby it has been concluded that the mixture 1 is not suitable as an aircraft-arresting paving material. In contrast, in case of the mixture 2, which corresponds to an exemplary embodiment of the present invention, the compression strengths of the specimens were in the range of about 3.5 kg/cm² to 4.5 kg/cm² when the concrete was in the cured condition, and the unit weights thereof were in the range of about 0.43 g/cm³ to 0.47/cm³ when the concrete was in the uncured condition, whereby it has been concluded that the mixture 2 is suitable as an aircraft-arresting paving material. In case of the mixture 3, which corresponds to an exemplary embodiment of the present invention, the compression strengths of the specimens were in the range of about 1.5 kg/cm² to 2.5 kg/cm² when the concrete was in the cured condition, and the unit weights thereof were in the range of about 0.38 g/cm³ to 0.42/cm³ when the concrete was in the uncured condition, whereby it has been concluded that the mixture 3 is suitable as an aircraft-arresting paving material. In case of the mixture 4, which corresponds to a comparative example, the compression strengths of the specimens were in an excessively low range of about 0.5 kg/cm² to 1 kg/cm² when the concrete was in the cured condition, and the unit weights thereof were in the range of about 0.33 g/cm³ to 0.37 g/cm³ when the concrete is in the uncured condition, whereby it has been concluded that the mixture 4 is not suitable as an aircraft-arresting paving material. In case of the mixture 5, which corresponds to a comparative example, it was not capable of maintaining the cubic shape when it was removed from a mold, whereby it was impossible to produce a specimen using the mixture 5. It is analyzed that the mixture was not capable of maintaining a shape of a concrete product due to the excessively low content of cement.

The inventive overrun prevention paving material, which is produced using a low-strength perlite concrete containing waterproof-coated perlite aggregates, may be used as an aircraft-arresting paving material for arresting (or rapid-braking) an aircraft by being installed at an end area of a runway and adapted to break under a load of an aircraft when the aircraft lands short of or overruns the end of the runaway, thereby making the aircraft stop by itself.

Especially, due to the low strength in the range of about 1.5 kg/cm² to 4.5 kg/cm² as described above, the inventive concrete forming the inventive overrun prevention paving material assures that the paving material breaks into fragments under the load of an aircraft which has broken away from a runway to cause the wheels of the aircraft to sink into the paving material, thereby arresting the aircraft. In addition, the concrete is easy to transport because it has a light unit weight in the range of 0.25 g/cm³ to 0.50 g/cm³.

Furthermore, the inventive low-strength and low-density waterproof-coated perlite concrete is not deteriorated in endurance and exhibits an excellent waterproofing performance even if it is exposed to moisture, rain, dust, and contaminants because the waterproof-coated perlite aggregates are used as a material for the concrete.

Although the present disclosure exemplified “aircraft-arresting” as a use of the inventive low-strength and low-density waterproof-coated perlite concrete and paving material, the object for overrun prevention is not necessarily limited to an aircraft, and the inventive low-strength and low-density waterproof-coated perlite concrete and paving material may also be used in order to prevent an overrun of other types of vehicles. Accordingly, the term, “aircraft,” used in the present disclosure should be construed to cover all the objects that require overrun prevention, like vehicles.

1. A low-strength and low-density waterproof-coated perlite concrete for an overrun prevention paving material, comprising:
perlite aggregates with a grain size of 1.5 mm to 2.0 mm, the perlite aggregates being waterproof-coated by being mixed with a siliconate-diluted water;
cement; and
mixing water,
wherein the perlite concrete contains the cement and the perlite aggregates in a volume ratio of 1:7 to 1:8, and contains the mixing water in a water/cement ratio (w/c ratio) of 50%, and wherein the overrun prevention paving material has a compression strength of 1.5 kg/cm² to 4.5 kg/cm², a porous ratio of 60% to 70%, and a unit weight of 0.35 g/cm³ to 0.50 g/cm³.

2. The perlite concrete as claimed in claim 1, wherein the perlite aggregates with a grain size of 1.5 mm to 2.0 mm are produced by preparing perlite aggregates with a grain size of 1.5 mm to 2.0 mm and water in a weight ratio of 1:1, adding a siliconate to the prepared water to form a siliconate-diluted water, mixing the siliconate-diluted water and the perlite aggregates, and then drying the perlite aggregates naturally or drying the perlite at a temperature in the range of about 100° C. to 110° C. for more than 24 hours.

3. An overrun prevention paving material that is produced from a low-strength waterproof-coated perlite concrete,
wherein the perlite concrete comprises waterproof-coated aggregates with a grain size of 1.5 mm to 2.0 mm, cement, and mixing water, the waterproof-coated aggregates being produced by preparing perlite aggregates with a grain size of 1.5 mm to 2.0 mm and water in a weight ratio of 1:1, adding a siliconate to the prepared water to form a siliconate-diluted water, mixing the siliconate-diluted water and the perlite aggregates, and then drying the perlite aggregates naturally or drying the perlite at a temperature in the range of about 100° C. to 110° C. for more than 24 hours,
wherein the perlite concrete contains the cement and the perlite aggregates in a volume ratio of 1:7 to 1:8, and the mixing water in a water/cement ratio (w/c ratio) of 50%,
wherein the overrun prevention paving material is produced by pouring the perlite concrete into a mold in an uncured state, compression-molding the low-strength waterproof-coated perlite concrete with a stress of 0.2 kg/cm² for 1 minute, and then, after a lapse of about 24 hours, air-curing the low-strength waterproof-coated perlite concrete in the state in which the mold is removed, and
wherein the overrun prevention paving material has a compression strength of 1.5 kg/cm² to 4.5 kg/cm², a porous ratio of 60% to 70%, and a unit weight of 0.25 g/cm³ to 0.5 g/cm³.

4. A method of producing an overrun prevention paving material, comprising:
preparing perlite aggregates with a grain size of 1.5 mm to 2.0 mm and water in a weight ratio of 1:1, adding a siliconate to the prepared water to form a siliconate-diluted water, mixing the siliconate-diluted water and the perlite aggregates, and then drying the perlite aggregates naturally or drying the perlite aggregates at a temperature in the range of about 100° C. to 110° C. for more than 24 hours, thereby producing waterproof-coated perlite aggregates with a grain size of 1.5 mm to 2.0 mm;
dry-mixing cement and the perlite aggregates in a volume ratio of 1:7 to 1:8;
adding mixing water to the dry-mixed mixture of the cement and the perlite aggregates in a water/cement ratio (w/c ratio) of 50%, and mixing again the mixing water and the dry-mixed mixture, thereby producing a low-strength waterproof-coated perlite concrete ; and
pouring the low-strength waterproof-coated perlite concrete into a mold in an uncured state, compression-molding the low-strength waterproof-coated perlite concrete with a stress of 0.2 kg/cm² for about 1 minute, and then removing the mold after a lapse of about 24 hours to air-cure the low-strength waterproof-coated perlite concrete, thereby producing an overrun prevention paving material having a compression strength of 1.5 kg/cm² to 4.5 kg/cm², a porous ratio of 60% to 70%, and a unit weight of 0.25 g/cm³ to 0.5 g/cm³.
